(19) United States
(12) Patent Application Publication
(10) Pub. No.: US 2010/0010166 A1
(43) Pub. Date: Jan. 14, 2010

(54) SILANE-TERMINATED PREPOLYMERS AND RELATIVE ADHESIVE SEALANT FORMULATIONS

(75) Inventors: Alessandro Galbiati, Gambolo (IT); Paolo Galbiati, Gambolo (IT)

Correspondence Address: NIXON PEABODY LLP - PATENT GROUP, 1100 CLINTON SQUARE, ROCHESTER, NY, 14604, US

(73) Assignee: N.P.T. S.R.L., Crespellano (IT)

(21) Appl. No.: 12/441,345

(22) PCT Filed: Sep. 14, 2007
(86) PCT No.: PCT/EP07/59731

§ 371 Date: Mar. 13, 2009

(30) Foreign Application Priority Data
Sep. 15, 2006 (IT) MI2006A001766

(51) Int. Cl. C08G 63/91; C08G 65/336; C08F 20/06; C08F 20/10; C08G 18/83; C08G 18/10

(52) U.S. Cl. 525/328.5; 525/329.7; 525/330.3; 525/418; 525/452

(57) ABSTRACT

Silane-terminated prepolymers which contain, on at least one silicon atom, at least one hydrolyzable aryloxy type functional group. The use of these prepolymers, containing silyl-aryloxy terminated groups, in adhesive sealant formulations increases their reactivity so enabling the use of metal-based catalysts, which are in most cases toxic and act as oxidation catalysts, to be avoided or their quantity to be reduced compared with the standard quantity used in conventional formulations, yet ensuring considerably shorter cross-linking times than those of formulations based on known silane-terminated prepolymers.

### FIELD OF THE INVENTION

The present invention relates to silane-terminated prepolymers and moisture-curing adhesive sealant formulations containing said prepolymers.

### STATE OF THE ART

Silane-terminated prepolymers are obtained by a polymerisation reaction of a known type for forming the main chain onto which are subsequently introduced terminal silane functional groups, themselves substituted by hydrolyzable monofunctional substituents such as alkoxy groups. These silane groups, by reaction with atmospheric humidity in the presence of suitable catalysts, hydrolyze with each other and combine giving rise to the formation of siloxane bonds, allowing the prepolymer to cross-link and to hence pass from the fluid state to the gummy state.

Various classes of silane-terminated prepolymers are known, i.e.:

A) Silane-terminated polyesters such as those described in U.S. Pat. No. 4,191,714 and U.S. Pat. No. 4,310,640,
B) Silane-terminated polyurethanes such as those described in U.S. Pat. No. 4,656,816 and U.S. Pat. No. 6,197,912,
C) Silane-terminated prepolymers in which the main chain is polyether which is subsequently reacted with molecules containing silane groups, Si(OR), where R is a hydrolyzable group, principally an alkyl group, such as those described in U.S. Pat. No. 5,051,463, U.S. Pat. No. 4,507,469, U.S. Pat. No. 4,444,974, U.S. Pat. No. 3,971,751 and EP 0844 266 A2.
D) Silane-terminated prepolymers as described in U.S. Pat. No. 6,221,994 and WO03/082958 in the name of the applicant in which the main polymer chain is obtained by Michael polyaddition reaction of an organic derivative containing at least 2 active hydrogens with organic compounds having at least two olefinic unsaturations, activated by the presence of an electronegative group in the alpha position with regard to each of said unsaturations.

Although the hydrolyzable groups present on the silicon in all four of the aforesaid silane-terminated prepolymer classes can differ in nature, the group of greatest interest is the alkoxy group because of the neutral and volatile nature of the alcohol that forms. However, for commercial products, the only alkoxy group present is methoxy as the hydrolysis reaction of this group is rather rapid. The hydrolysis reaction of this group leads to the formation of large amounts of methanol which is very toxic not least because of its high volatility.

However, substituting this group with one containing more carbon atoms such as ethoxy causes the cross-linking reaction to slow down considerably, hence resulting in the need to increase the amount of cross-linking catalysts.

The catalysts used for speeding up cross-linking of the aforesaid prepolymers are usually salts of tin or other very toxic heavy metals which present the further disadvantage of entering into the oxidative degradation cycle of the finished products.

The need was therefore felt to find silane-terminated prepolymers which would not present the aforesaid drawbacks.

### SUMMARY OF THE INVENTION

The applicant has now unexpectedly discovered silane-terminated prepolymers characterized by presenting on at least one silicon atom at least one hydrolyzable aryloxy type functional group.

In this respect the applicant has surprisingly found that using these aryloxy-terminated prepolymers in adhesive sealant formulations increases their reactivity, enabling the use of toxic metal salt based catalysts to be avoided or in any case their quantity to be greatly reduced compared with the amount normally used in conventional formulations, yet ensuring brief cross-linking times.

Moreover, by introducing aryloxy groups the reactivity of ethoxy-silyl terminated prepolymers (or alkoxy groups of higher molecular weight) can be increased thus rendering them useful in formulating adhesive and sealant products, hence avoiding the use of silane-terminated prepolymers containing methoxy groups which release toxic methanol during product application; indeed ethoxy-terminated prepolymers are known to be poorly reactive to atmospheric humidity and the release of very volatile and toxic methanol is an increasingly felt problem in this field.

Furthermore, the substitution of low molecular weight alkoxy groups (e.g. methoxy) with suitable aryloxy groups in the cross-linking stage also has a lower environmental impact in that the amount of VOC emitted into the atmosphere is considerably reduced during product application.

The present invention therefore also relates to moisture-curing adhesive sealant formulations containing the aforesaid silane prepolymers.

### DETAILED DESCRIPTION OF THE INVENTION

In the present description “aryloxy” is defined as a possibly substituted phenoxy group, or a possibly substituted phenoxy group onto which at least one other aromatic ring, such as a naphthyloxy, is condensed.

Preferably the aryloxy groups are chosen from: phenoxy, phenoxy substituted at the o-, and/or m-, and/or p-positions with linear or branched C₁-C₂₀ alkyl, alkylaryl (e.g. cumyl), alkoxy, phenyl, phenoxy, substituted phenyl, thioalkyl, nitro, halogen, nitrile, carboxyalkyl, carboxyamide, NH₂, NHR groups in which R is a linear or branched C₁-C₅ alkyl or phenyl.

Even more preferably the aryloxy groups are chosen from: phenoxy, linear or branched p-C1-C12 alkyl phenoxy, phenyl-phenoxy.

In accordance with particularly preferred embodiments they are chosen from phenoxy, p-t-butyl-phenoxy, p-nonylphenoxy, p-dodecylphenoxy, p-t-amylphenoxy, p-t-octylphenoxy, p-cumylphenoxy, 3,5-xylenoxy, di-sec-butylphenoxy, 2-sec-4-tert-butylphenoxy, 2,4-di-tert-amylphenoxy, ortho-cumyl-octylphenoxy, 3,4-(Methylenedioxy)-phenoxy, 4′-hydroxy-biphenyl-4-carbonitrile, 4-phenoxyphenoxy, polyphenylenoxide phenoxy terminated, 4-phenylphenoxy, 1-naphthoxy, 2-naphthoxy.

In each case those aryloxy groups able to produce high boiling arylalcohols, and hence low VOC emission, are preferred.

The aryloxy groups in the silane-terminated prepolymer of the present invention are preferably present in quantities of between 0.5 and 100%, more preferably between 5 and 100 mol % on the total moles of hydrolyzable substitutents present on all silicon atoms of said silane-terminated prepolymer.

Preferably the organic silicon derivative with which the silane-terminated prepolymers are prepared according to the present invention has the following general formula (1):

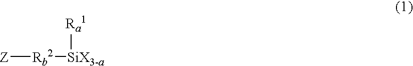

with a=0, 1, 2; b=0, 1 and where:
X=aryloxy, halogen, hydroxy, alkoxy, acyloxy, ketoximino, amino, amido and mercapto.
R¹=linear or branched C¹-C²⁰ alkyl
R²=divalent substituent chosen from the group consisting of linear or branched C₁-C₂₀ alkylene, heterocycloalkylenes, aminoalkylenes, alkylene thioethers, alkylene oxyethers;
Z=substitutent chosen from:

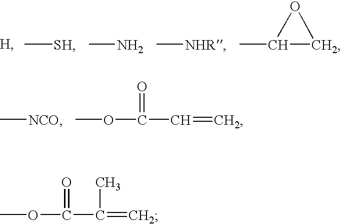

in which R″ represents a monovalent hydrocarbon group or a monovalent group able to form a heterocycloalkyl with the nitrogen atom.

For preparing the silane-terminated prepolymers in accordance with the present invention organic silicon derivatives can be used in which X is always different from aryloxy.

Subsequently the silane-terminated prepolymers thus obtained are converted into the silane-terminated prepolymers of the present invention by reaction with the corresponding aryl alcohol.

Preferably the organic silicon derivatives used in the present invention present the following formulae:

O═C═N—R³—Si(R⁴)ₐ(OR⁵)₃₋ₐ (1a)

H₂N—R³—Si(R⁴)ₐ(OR⁵)₃₋ₐ (1b)

O[CH₂—CH]—CH₂—O—R³—Si(R⁴)ₐ(OR⁵)₃₋ₐ (1c)

HS—R³—Si(R⁴)ₐ(OR⁵)₃₋ₐ (1d)

CH₂═C(R⁶)—COO—R³Si(R⁴)ₐ(OR⁵)₃₋ₐ, (1e)

HL-R³—Si(R⁴)ₐ(OR⁵)₃₋ₐ (1f)

where:
R³=divalent alkyl radical containing from 1 to 8 carbon atoms;

R⁴ and R⁵=alkyl radicals containing from 1 to 4 carbon atoms and/or aryl radicals;

L is a divalent group of a 5- or 6-atom saturated heterocyclic ring containing at least one nitrogen atom;
a=0, 1, 2.

In the present description “aryl radical” means a possibly substituted phenyl, or a possibly substituted phenyl onto which at least one other aromatic ring such as a naphthyl is condensed.

Preferably the aryl group is chosen from phenyl, naphthyl possibly substituted at the o-, and/or m-, and/or p-positions with linear or branched C₁-C₂₀ alkyl, alkylaryl (e.g. cumyl), alkoxy, phenyl, substituted phenyl, thioalkyl, nitro, halogen, nitrile, carboxyalkyl, carboxyamide, NH₂, NHR groups in which R is a linear or branched C₁-C₅ alkyl or phenyl.

Even more preferably the group is chosen from phenyl, linear or branched p-C₁-C₁₂ alky phenyl, p-phenyl-phenyl.

In accordance with particularly preferred embodiments the group is chosen from p-t-butyl-phenyl, p-nonylphenyl, p-dodecylphenyl, p-t-amylphenyl, p-t-octylphenyl, p-cumylphenyl, 3.5-xylenyl, di-sec-butylphenyl, 2-sec-4-tert-butylphenyl, 2,4-di-tert-amylphenyl, ortho-cumyl-octylphenyl, 3,4-(Methylenedioxy)-phenyl, 4′-biphenyl-4-carbonitrile, 4-phenoxyphenyl, polyphenylenoxide phenyl terminated, 4-phenylphenyl, 1-naphthyl, 2-naphthyl.

Preferably L is the divalent residue of piperazine.

In accordance with a particularly preferred embodiment the organic silicon derivatives used for preparing the silane-terminated prepolymers of the present invention are chosen from:
1. (3-mercaptopropyl)trimethoxysilane,
2. (3-mercaptopropyl)dimethoxyphenoxysilane,
3. (3-mercaptopropyl)methoxydiphenoxysilane,
4. (3-mercaptopropyl)triphenoxysilane,
5. (3-mercaptopropyl)dimethoxy-ptbutphenoxysilane
6. (3-mercaptopropyl)methoxy-diptbutphenoxysilane,
7. (3-mercaptopropyl)triptbutphenoxysilane,
8. (3-mercaptopropyl)methyl-dimethoxysilane,
9. (3-mercaptopropyl)methyl-methoxy-phenoxysilane,
10. (3-mercaptopropyl)methyl-diphenoxysilane,
11. (3-mercaptopropyl)methyl-methoxyptbutphenoxysilane,
12. (3-mercaptopropyl)methyl-diptbutphenoxysilane,
13. (3-[meta]acryloxypropyl)trimethoxysilane,
14. (3-[meta]acryloxypropyl)dimethoxyphenoxysilane,
15. (3-[meta]acryloxypropyl)methoxydiphenoxysilane,
16. (3-[meta]acryloxypropyl)triphenoxysilane,
17. (3-[meta]acryloxypropyl)dimethoxy-ptbutphenoxysilane,
18. (3-[meta]acryloxypropyl)methoxy-diptbutphenoxysilane,
19. (3-[meta]acryloxypropyl)triptbutphenoxysilane,
20. (3-acryloxypropyl)trimethoxysilane,
21. (3-acryloxypropyl)dimethoxyphenoxysilane,
22. (3-acryloxypropyl)methoxydiphenoxysilane,
23. (3-acryloxypropyl)tri phenoxysilane,
24. (3-acryloxypropyl)dimethoxy-ptbutphenoxysilane,
25. (3-acryloxypropyl)methoxy-diptbutphenoxysilane,
26. (3-acryloxypropyl)triptbutphenoxysilane,
27. (N-nButyl,3-aminopropyl)trimethoxysilane,
28. (N-nButyl,3-aminopropyl)dimethoxyphenoxysilane,
29. (N-nButyl,3-aminopropyl)methoxydiphenoxysilane,
30. (N-nButyl,3-aminopropyl)triphenoxysilane,
31. (N-nButyl,3-aminopropyl)dimethoxy-ptbutphenoxysilane,
32. (N-nButyl,3-aminopropyl)methoxy-diptbutphenoxysilane,
33. (N-nButyl,3-aminopropyl)triptbutphenoxysilane,
34. (N-Ethyl,3-aminopropyl)trimethoxysilane,
35. (N-Ethyl,3-aminopropyl)dimethoxyphenoxysilane,
36. (N-Ethyl,3-aminopropyl)methoxydiphenoxysilane,
37. (N-Ethyl,3-aminopropyl)triphenoxysilane,
38. (N-Ethyl,3-aminopropyl)dimethoxy-ptbutphenoxysilane,
39. (N-Ethyl,3-aminopropyl)methoxy-diptbutphenoxysilane,
40. (N-Ethyl,3-aminopropyl)triptbutphenoxysilane,
41. (3-glycidoxypropyl)trimethoxysilane,
42. (3-glycidoxypropyl)dimethoxyphenoxysilane,
43. (3-glycidoxypropyl)methoxydiphenoxysilane,
44. (3-glycidoxypropyl)triphenoxysilane,
45. (3-glycidoxypropyl)dimethoxy-ptbutphenoxysilane,
46. (3-glycidoxypropyl)methoxy-diptbutphenoxysilane,
47. (3-glycidoxypropyl) triptbutphenoxysilane,
48. N-[3-(trimethoxysilyl)propyl]piperazine,
49. N-[3-(dimethoxy-phenoxysilyl)propyl]piperazine,
50. N-[3-(methoxy-diphenoxysilyl)propyl]piperazine,
51. N-[3-(triphenoxysilyl)propyl]piperazine,
52. N-[3-(dimethoxy-ptbutphenoxysilyl)propyl]piperazine,
53. N-[3-(methoxy-diptbutphenoxysilyl)propyl]piperazine,
54. N-[3-(triptbutphenoxysilyl)propyl]piperazine,
55. N-[3-(triethoxy-silyl)propyl]piperazine,
56. N-[3-(diethoxy-phenoxysilyl)propyl]piperazine,
57. N-[3-(ethoxy-diphenoxysilyl)propyl]piperazine,
58. N-[3-(diethoxy-ptbutphenoxysilyl)propyl]piperazine,
59. N-[3-(ethoxy-diptbutphenoxysilyl)propyl]piperazine,
60. N-[(triethoxy-silyl)methyl]piperazine,
61. N-[(diethoxy-ptbutphenoxysilyl)methyl]piperazine,
62. N-[(diethoxy-methylsilyl)methyl]piperazine,
63. N-[(ethoxy-methyl-ptbutphenoxysilyl)methyl]piperazine.

The silane-terminated prepolymers of the present invention are preferably chosen from the previously indicated (A), (B), (C) and (D) classes and are more preferably chosen from class (D), i.e. those described in U.S. Pat. No. 6,221,994 and WO03/082958 in the name of the applicant and incorporated by us as reference in their entirety, in which the main polymer chain is obtained by Michael polyaddition reaction of an organic derivative containing at least 2 active hydrogen atoms with organic compounds having at least two double bonds activated by the presence of an electronegative group in the alpha position with respect to each of said double activated double bonds.

The structures of the Michael polyaddition linear polymers useful for being silanated in accordance with the present invention, can be prepared for example as shown in scheme (2) and scheme (3).

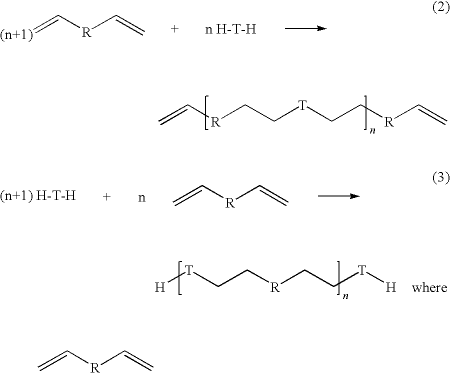

is any organic compound having two activated double bonds and n is a whole number greater than or equal to 1 and HTH is the organic derivative having at least 2 active hydrogen atoms.

Further examples of structures of branched Michael polyaddition polymers useful for being silanated according to the present invention, prepared from at least one monomer having more than two activated double bonds and HTH, and characterized by different terminal functional groups on the basis of the ratio between the monomers, can be illustrated (which is not, and cannot be, an attempt at reality) as in scheme (4) and scheme (5), where the HTH compound in the specific example is sulphydric acid

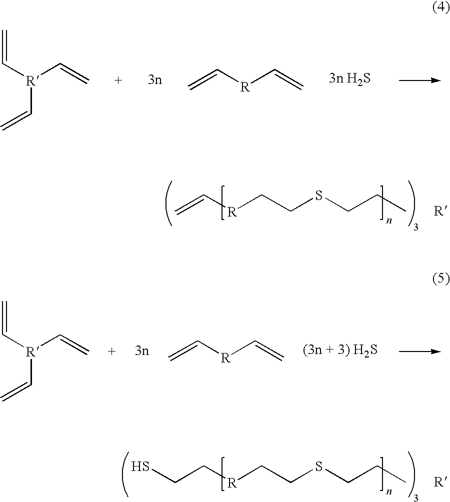

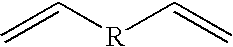

is any organic compound having two activated double bonds and n is a whole number greater than or equal to 1

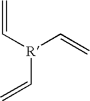

is any organic compound having three activated double bonds and n is a whole number greater than or equal to 1 and c=3

Not reported herein, for the obvious difficulties related to graphical representation, are all the branched structures obtainable with monomers having more than two activated double bonds and with combinations of monomers of functionality greater than two with monomers of functionality equal to or greater than two. It is evident, however, that for the purpose of this patent any combination of monomers with different degrees of functionality able to produce a viscous fluid polymer is useful (at any temperature and, accordingly, below its gelling point) having terminal functional groups useful for subsequent silanisation with organic silicon derivatives, preferably with the silanes of formula (I). The average numerical molecular weights of said polymers are pre-chosen on the basis of the ratio between the monomers and are selected on the basis of the nature of the monomers themselves and of the final use to which the polymer is destined. Such values can be between 200 daltons and 60000 daltons.

In a preferred embodiment of the present invention, the organic compounds useful for Michael polyaddition having at least two activated double bonds are chosen from:

W′[—C(R⁷)═CH₂]₂ (9)

Q[-W—C(R⁷)═CH₂]₂ (9a)

Q[-W—C(R⁷)═CH₂]₃ (9b)

Q[-W—C(R⁷)═CH₂]₄ (9c)

where:
W′=electron attracting group chosen from the group consisting of:

### —SO—, —SO₂—, —O—, —CO—;

W=electron attracting group chosen from the group consisting of:

### —SO—, —SO₂—, —O—, —CO—, —O—CO—;

### R⁷═—H or —CH₃;

Q=divalent, trivalent or tetravalent group chosen from hydrocarbon, hetero-hydrocarbon, polyether, polyester radicals that can contain repeating units and hence have variable molecular weights.

In a particularly preferred embodiment the acrylic and/or methacrylic organic compounds have the general formula:

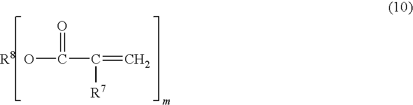

where m=2, 3, 4; R⁷=H or CH₃; R⁸ is chosen from the group consisting of: di-, tri- or tetra-valent polyether which essentially consists of chemically combined —OR⁹—units, where R⁹ is a divalent alkyl group having from 2 to 4 carbon atoms; di-, tri- or tetra-valent linear or branched aliphatic alkyl radical, preferably from 1 to 50 carbon atoms; di-, tri- or tetra-valent aromatic radical, preferably from 6 to 200 carbon atoms; di-, tri- or tetra-valent linear or branched aryl radical, preferably from 6 to 200 carbon atoms or R is one or more combinations of said polyethers, alkyl radicals, aromatic radicals and aryl radicals.

Structures of organic compounds having at least two activated alkylene bonds are given below by way of example.

H₂C═C(R⁷)—SO₂—C(R⁷)═CH₂,

H₂C═C(R⁷)—SO—C(R⁷)═CH₂,

H₂C═C(R⁷)—O—C(R⁷)═CH₂,

CH₃CH₂C[CH₂O—CO—C(R⁷)═CH₂]₃,

### C[CH₂O—CO—C(R⁷)═CH₂]₄,

O{CH₂C(C₂H₅)(CH₂O—CO—C(R⁷)═CH₂)₂}₂,

H₂C═C(R⁷)—CO—O-Ph-C(CH₃)₂-Ph-O—CO—C(R⁷)═CH₂,

H₂C═C(R⁷)—CO—OCH₂CH₂O—CO—C(R⁷)═CH₂,

H₂C═C(R⁷)—CO—OCH₂CH(CH₃)CH₂O—CO—C(R⁷)═CH₂,

C[CH₂-[OCH₂CH(CH₃)]ₙOCOC(R⁷)═CH₂]₄,

H₂C═C(R⁷)—CO—O(CH₂CH₂O)ₙ—CO—C(R⁷)═CH₂,

H₂C═C(R⁷)—CO—O[CH₂CH(CH₃)O]ₙ—CO—C(R⁷)═CH₂,

CH{CH₂O[CH₂CH(CH₃)O]ₙ—CO—C(R⁷)═CH₂}₃,

H₂C═CH—SO₂—(CH₂CH₂O)ₙ—CH₂CH₂—SO₂—CH═CH₂

H₂C═C(R⁷)—CO—O—[R—O—CO—R′—CO—O]ₙ—R—O—CO—C(R⁷)═CH₂,

where: R7=H or CH₃; R and R′=alkyl or aryl radicals.

Preferably the organic compounds useful for Michael polyaddition, having at least two activated double bonds, are chosen from: di-, tri- and tetra-acrylates; di-, tri- and tetra-methacrylates; di-, tri- and tetra-vinyl sulfones.

According to the present invention, the most preferred of the diacrylate and dimethacrylate organic compounds are chosen from the group consisting of: compounds of general formula (11)

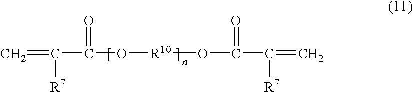

where:
R⁷═H or CH₃; R¹⁰=chosen from the group consisting of —CH₂—CH(CH₃)—, —CH₂—CH₂—, —CH₂—CH₂—CH₂—CH₂—; —CH₂—CH(CH₃)—CH₂—; n′=whole number from 1 to 400, preferably from 1 to 200, even more preferably from 1 to 50; compounds of formula:

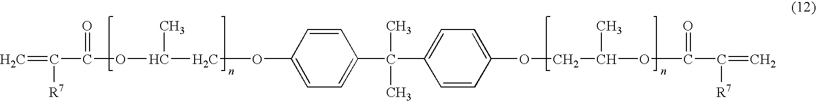

where n is a whole number from 0 to 10 and R7 is H or CH3.

Preferred by far of the compounds of formula (II) are the compounds in which R⁷ is hydrogen and R10 is chosen from:

—CH₂—CH(CH₃)—, and —CH₂CH₂CH₂CH₂— i.e. polyisopropylene glycol diacrylates, polybutylene glycol diacrylates.

Preferred among the organic triacrylates and trimethacrylates are:

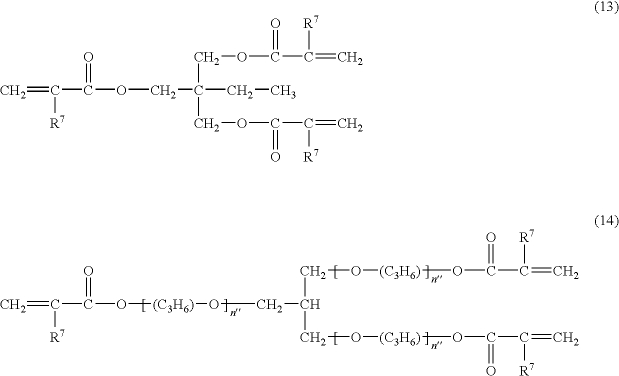

where:
R7=H or CH3; n″=whole number from 0 to 400, preferably from 0 to 200 and even more preferably from 0 to 50.

Preferred among the vinyl sulfonic organic compounds are:

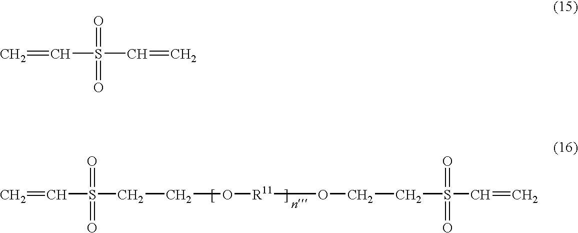

where R¹¹ is chosen from CH₂—CH(CH₃)—, —CH₂—CH₂—, —CH₂—CH₂—CH₂—CH₂—; —CH₂—CH(CH₃)—CH₂—;
n′″=a whole number from 0 to 400, preferably from 0 to 200 and even more preferably from 0 to 50.

The compound of formula H-T-H is an organic compound having at least 2 active hydrogen atoms.

It is preferably chosen from:

sulphydric acid, HS(CH₂)ₙSH, HSPhSH, CH₃(CH₂)₃NH₂, H₂N(Ph)NH₂, piperazine, H₂N(CH₂)ₙNH₂, CH₃NH(CH₂)ₙNHCH₃, CH₂(COOH)₂.

Some examples of the preparation of the silane-terminated prepolymers of the present invention are given by way of non-limiting illustration together with cross-linking tests of said prepolymers and compared with those of the formulations containing silane-terminated prepolymers but not containing aryloxy groups.

### COMPARATIVE EXAMPLES

### Example A

### Synthesis of trimethoxy-silyl terminated prepolymer

The reaction is carried out in a steel reactor of approximately 300 litre capacity equipped with mechanical stirring.

2.45 kg of piperazine (28.442 mols) are added to 192.20 kg (46.685 mols) of a polypropylene glycol diacrylate having average numerical molecular weight <Mn>=4117 g/mol (by titration of double bonds with dodecyl mercaptan) under stirring and in the presence of 38.44 kg of dioctylphthalate. The reaction is conducted at 80° C. for 14 hours, that is to say until ¹H-NMR analysis confirms the disappearance of the triplet at 2.84 ppm corresponding to methylene in the alpha position with respect to the piperazine NH groups (total conversion of NH groups). The double bond terminated prepolymer thus obtained, when subjected to analysis of double bond concentration, showed a molecular weight equal to <Mn>=10456 g/mol. Subsequently 9.71 kg (39.09 mols) of N-[3-(trimethoxysilyl)propyl]piperazine are added slowly under agitation, at T=90° C., in a dry nitrogen atmosphere.

After 9 hours the desired product is obtained as confirmed by ¹H-NMR analysis showing the complete disappearance of the signals corresponding to the acrylic double bonds in the region between 5.6 ppm and 6.5 ppm.

The prepolymer thus obtained appears as a transparent viscous fluid, reactive towards atmospheric humidity and having a viscosity of 11600 mPas at 23° C.

### Example B

### Synthesis of triethoxy-silyl terminated prepolymer

The reaction is undertaken in a 30 litre capacity glass reactor equipped with mechanical agitation.

180.93 g of piperazine (2.10 mols) are added to 14.32 kg (3.60 mols) of polypropylene glycol diacrylate having <Mn>=3977 g/mole (by titration of double bonds) under stirring in the presence of 2.86 kg of dioctyl phthalate. The reaction is conducted at 80° C. for 14 hours, that is to say until ¹H-NMR analysis confirms total conversion of piperazine NH groups. Titration of double bonds showed a molecular weight equal to <Mn>=11312.

781.8 g (2.69 mols) of N-[3-(triethoxysilyl)propyl]piperazine silane are added to the thus obtained prepolymer at T=90° C., under stirring and in a dry nitrogen atmosphere.

After 9 hours the desired product is obtained as confirmed by ¹H-NMR analysis showing the complete disappearance of the signals corresponding to the acrylic double bonds in the region between 5.6 ppm and 6.5 ppm.

The prepolymer thus obtained appears as a transparent viscous fluid, reactive towards atmospheric humidity and having a viscosity of 9400 mPas at 23° C.

### Example C

### Preparation of trimethoxy-silyl terminated prepolymer formulation

100 parts by weight of Michael polyaddition polymer (Example A) are mixed with 100 parts of calcium carbonate (previously dried in a dryer), 10 parts of titanium dioxide, 0.5 parts of an antioxidant, 10 parts of vinyl trimethoxy silane as water scavenger and a polyamide wax in a variable quantity depending on the desired rheological characteristics. Mixing is undertaken in a planet mixer under nitrogen atmosphere, heating the mix at 80° C. for 2 hours. The catalyst DBTL (see Table 3) and 1 part of 3-aminopropyltrimethoxy silane as adhesion promoter are then added. The thixotropic fluid thus obtained is degassed and placed in metal pouches where it remains over time without significant changes in its characteristics.

When exposed to atmospheric humidity the product forms an elastic non-tacky skin depending on the amount of catalyst added and hardens completely in less than 24 hours depending on the thickness of the material.

The hardened product possesses the following mechanical properties:

Shore A hardness=35 Elongation at break>130% and

### Modulus at 100%=1.0 Mpa

### Example D

### Preparation of triethoxy-silyl terminated prepolymer formulation

100 parts by weight of Michael polyaddition polymer (Example B) are mixed with 100 parts of calcium carbonate (previously dried in a dryer), 10 parts of titanium dioxide, 0.5 parts of an antioxidant, 10 parts of vinyl triethoxy silane as water scavenger and a polyamide wax in a varying quantity. Mixing is undertaken in a planet mixer under nitrogen atmosphere, heating the mix at 80° C. for 3 hours. The catalyst DBTL (see Table 3) and 1 part of N-(2-aminoethyl)-3-aminopropyltriethoxy silane as adhesion promoter are then added. The thixotropic fluid thus obtained is degassed and placed in metal pouches where it remains over time without significant changes in its characteristics.

When exposed to atmospheric humidity the product forms an elastic and non-tacky skin depending on the amount of catalyst added and hardens completely in less than 24 hours depending on the thickness of the material.

The hardened product possesses the following mechanical properties:

Shore A hardness=25 Elongation at break>150% and

### Modulus at 100%=0.8 Mpa

### Example 1

### Synthesis of dimethoxy/p-tertbutylphenoxy-silyl terminated prepolymer (moles/moles=66/33)

1.98 g (0.0054 mols) of N-[3-(dimethoxy-p-tertbutylphenoxy-silyl)propyl]piperazine are added to 33.06 g (0.00257 mols) of the double bond terminated prepolymer obtained as in comparative example A, but having <Mn>=10728 g/mol. The reaction is conducted in a 100 ml three-neck glass flask equipped with mechanical stirrer, at T=100° C. under stirring and under light nitrogen pressure.

After 9 hours the reaction is terminated as confirmed by ¹H-NMR analysis showing the complete disappearance of the signals corresponding to the acrylic double bonds.

The prepolymer thus obtained appears as a transparent viscous fluid, reactive towards atmospheric humidity and having viscosity of 15300 mPas at 23° C.

### Example 2

### Synthesis of methoxy/p-tertbutylphenoxy-silyl terminated prepolymer (moles/moles=50/50)

A batch of the product obtained in comparative example A (102.01 g) is placed in a 250 ml three-neck glass flask equipped with mechanical agitation and connection to a mechanical vacuum pump. The temperature is brought to 110° C. and 4.35 g of p-tertbutylphenol (the necessary quantity to substitute about 50 molar % of methoxyl groups) are added.

The reaction is conducted under a dynamic vacuum (1 mbar residual) with vigorous agitation and the methanol released is collected in a liquid nitrogen trap.

After 8 hours a quantity of methanol equal to the theoretical is collected and the reaction is considered complete.

The prepolymer thus obtained appears as a transparent viscous fluid, reactive towards atmospheric humidity and having a viscosity of 15100 mPas at 23° C.

### Example 3

### Synthesis of methoxy/di-p-tertbutylphenoxy-silyl terminated prepolymer (moles/moles=33/66)

2.82 g (0.00583 mols) of N-[3-(methoxy-di-p-tertbutylphenoxy-silyl)propyl]piperazine are added to 35.68 g (0.00278 mols) of the double bond terminated prepolymer obtained as in comparative example A, but having <Mn>=10728 g/mole.

The reaction is conducted in a three-neck 100 ml flask at T=100° C. under a head of nitrogen and with mechanical stirring.

After 9 hours the reaction is completed as confirmed by ¹H-NMR analysis showing the complete disappearance of the signals corresponding to the acrylic double bonds.

The polymer thus obtained appears as a transparent viscous fluid, reactive towards atmospheric humidity and having a viscosity of 17800 mPas at 23° C.

### Example 4

### Synthesis of methoxy/p-tertbutylphenoxy-silyl terminated prepolymer (moles/moles=25/75)

A batch of the product obtained in comparative example A (140.71 g) is placed in a 250 ml glass flask equipped with mechanical agitation and connection to a mechanical vacuum pump. The temperature is brought to 110° C. and 7.66 g of p-tertbutylphenol (the necessary quantity to substitute about 75 molar % of methoxyl groups) are added.

The reaction is conducted under a dynamic vacuum (1 mbar residual) with vigorous stirring and the methanol released is collected in a liquid nitrogen trap.

After 10 hours a quantity of methanol is collected equal to the theoretical, and the reaction is considered complete.

The polymer thus obtained appears as a transparent viscous fluid reactive towards atmospheric humidity and having a viscosity of 17200 mPas at 23° C.

### Example 5

### Synthesis of p-tertbutylphenoxy-silyl terminated prepolymer(moles/moles=0/100)

A batch of the product obtained in comparative example A (28.06 g) is placed in a three-neck 100 ml glass flask equipped with mechanical stirring and connection to a mechanical vacuum pump. The temperature is brought to 110° C. and 2.04 g of p-tertbutylphenol (the necessary quantity to substitute all methoxyl groups) are added.

The reaction is conducted under a dynamic vacuum (1 mbar residual) with vigorous stirring and the methanol released is collected in a liquid nitrogen trap.

After 10 hours a quantity of methanol is collected equal to the theoretical, and the reaction is considered complete.

The polymer thus obtained appears as a transparent viscous fluid reactive towards atmospheric humidity and having a viscosity of 20500 mPas at 23° C.

### Example 6

### Synthesis of p-tertbutylphenoxy-silyl terminated prepolymer (moles/moles=0/100)

3.33 g (0.00554 mols) of N-[3-(Tri p-tertbutylphenoxy-silyl)propyl]piperazine are added to 33.88 g (0.00264 mols) of the double bond terminated prepolymer obtained as in comparative example A, but having <Mn>=10728 g/mole.

The reaction is conducted in a three-neck 100 ml flask at T=100° C. under nitrogen head and with mechanical stirring. After 9 hours the reaction is complete.

The polymer thus obtained appears as a transparent viscous fluid, reactive towards atmospheric humidity and having a viscosity of 23000 mPas at 23° C.

### Example 7

### Synthesis of ethoxy/p-tertbutylphenoxy-silyl terminated prepolymer (40/60)

A batch of the product obtained in comparative example B (138.7 g) is placed in a three-neck 250 ml glass flask equipped with mechanical stirring and connected to a mechanical vacuum pump. The temperature is brought to 110° C. and 5.56 g of p-tertbutylphenol (the necessary quantity to substitute 60 molar % of ethoxyl groups) are added.

The reaction is conducted under a dynamic vacuum (1 mbar residual) with vigorous agitation and the ethanol released is collected in a liquid nitrogen trap.

After 8 hours a quantity of ethanol is collected equal to the theoretical, and the reaction is considered complete.

The polymer thus obtained appears as a transparent viscous fluid reactive towards atmospheric humidity and having a viscosity of 11300 mPas at 23° C.

### Example 8

### Synthesis of ethoxy/p-tertbutylphenoxy-silyl terminated prepolymer (25/75)

A batch of the product obtained in comparative example B (220.67 g) is placed in a three-neck 500 ml glass flask equipped with mechanical agitation and connection to a mechanical vacuum pump. The temperature is brought to 110° C. and 11.06 g of p-tertbutylphenol (the necessary quantity to substitute about 75 molar % of ethoxyl groups) are added.

The reaction is conducted under a dynamic vacuum (1 mbar residual) with vigorous agitation and the ethanol released is collected in a liquid nitrogen trap.

After 8 hours a quantity of ethanol is collected equal to the theoretical, and the reaction is considered complete.

The polymer thus obtained appears as a transparent viscous fluid reactive towards atmospheric humidity and having a viscosity of 12500 mPas at 23° C.

### Example 9

### Synthesis of ethoxy/p-tertbutylphenoxy-silyl terminated prepolymer (5/95)

A batch of the product obtained in comparative example B (123.77 g) is placed in a three-neck 250 ml glass flask equipped with mechanical stirring and connection to a mechanical vacuum pump. The temperature is brought to 110° C. and 7.86 g of p-tertbutylphenol (the necessary quantity to substitute about 95 molar % of ethoxyl groups) are added.

The reaction is conducted under a dynamic vacuum (1 mbar residual) with vigorous stirring and the ethanol released is collected in a liquid nitrogen trap.

After 9 hours a quantity of ethanol is collected equal to the theoretical, and the reaction is considered complete.

The polymer thus obtained appears as a transparent viscous fluid reactive towards atmospheric humidity and having a viscosity of 19500 mPas at 23° C.

### Example 10

### Preparation of methoxy/p-tertbutylphenoxy-silyl terminated prepolymer formulation (moles/moles=25/75)

100 parts by weight of Michael polyaddition polymer (Example 4) are mixed with 100 parts of calcium carbonate (previously dried in dryer), 10 parts of titanium dioxide, 0.5 parts of an antioxidant, 10 parts of vinyl trimethoxy silane as water scavenger and a polyamide wax in a variable quantity depending on the desired Theological characteristics. Mixing is undertaken in a planet mixer under nitrogen atmosphere, heating the mix at 80° C. for 2 hours. The catalyst DBTL or DBU (see Table 3) and 1.5 parts of 3-aminopropyltrimethoxy silane as adhesion promoter are then added. The thixotropic fluid thus obtained is degassed and placed in metal pouches where it remains over time without significant changes in its characteristics.

When exposed to atmospheric humidity the product forms an elastic non-tacky skin depending on the amount of catalyst added and hardens completely in less than 24 hours depending on the thickness of the material.

The hardened product possesses the following mechanical properties:

Shore A hardness=35 Elongation at break>150% and

### Modulus at 100%=1.2 Mpa

### Example 11

### Preparation of ethoxy/p-tertbutylphenoxy-silyl terminated prepolymer formulation (5/95)

100 parts by weight of Michael polyaddition polymer (Example 9) are mixed with 100 parts of calcium carbonate (previously dried in a dryer), 10 parts of titanium dioxide, 0.5 parts of an antioxidant, 10 parts of vinyl triethoxy silane as water scavenger and a polyamide wax in a varying quantity. Mixing is undertaken in a planet mixer under a nitrogen atmosphere, heating the mix at 80° C. for 3.5 hours. The catalyst DBTL or DBU (see Table 3) and 2 parts of N-(2-aminoethyl)-3-aminopropyltriethoxy silane as adhesion promoter are then added. The thixotropic fluid thus obtained is degassed and placed in metal pouches where it remains over time without significant changes in its characteristics.

When exposed to atmospheric humidity the product forms an elastic non-tacky skin depending on the amount of catalyst added and hardens completely in less than 24 hours depending on the thickness of the material.

The hardened product possesses the following mechanical properties:

Shore A hardness=30 Elongation at break>130% and

### Modulus at 100%=1.0 Mpa

### Evaluating Reactivity of the Prepolymers

The following demonstrates how the introduction of aryloxy groups leads to an unexpected increase in prepolymer reactivity to atmospheric humidity and how an increased reactivity corresponds to a greater substitution.

The prepolymers obtained in examples A and B and in examples 1-9, if conserved in a moisture-free atmosphere, remain stable in the form of viscous fluids without significant variations in viscosity. However, over a time-period that varies depending on their reactivity, they transform into a gummy solid (polymer cross-linking) on exposure to atmospheric humidity as a result of the hydrolysis reaction of the silane groups and subsequent condensation of the silanol groups to form siloxane groups.

The prepolymers are hereinafter evaluated both in the absence of a hydrolysis/condensation reaction catalyst for the terminal silane groups and with the addition of catalysts known in the art, namely the metal compound dibutyltin dilaurate (DBTL) and the amine catalyst 1,8-diazabicyclo[5.4.0]undec-7-ene (DBU) in varying proportions.

An approximately 3.5 g polymer sample is mixed with a suitable quantity of catalyst (Table 1 and Table 2) under nitrogen atmosphere and subsequently placed in a PTFE dish-type sample holder of 34 mm diameter and 5 mm height; the entirety is placed in a temperature controlled chamber at 23° C.±1° C. and relative humidity of 50%±5%.

The reactivity is evaluated by monitoring the formation of surface skin over time, placing the exposed surface in contact with a polyethylene sheet (table 1 and table 2).

### Evaluating Reactivity of the Formulations

The formulations obtained in examples C and D and examples 10-11 conserved in pouches remain stable in the form of thixotropic fluids without significant variations in viscosity. However, over a time-period that varies depending on the reactivity of the prepolymers of which they are composed, they transform into a gummy solid (polymer cross-linking) by exposure to atmospheric humidity.

The following demonstrates how the use of prepolymers containing aryloxy groups increases the reactivity of the formulations and how this enables catalyst use to be avoided, or to be used in quantities far lower than standard, yet maintaining rapid hardening rates. This satisfies market requirements, which favour quick-acting products (adhesives sector: tack free time 20-30 minutes) while avoiding the drawbacks of using catalysts in high amounts. The absence, or the reduced quantity, of metal salts leads to a combination of lower toxicity of the formulations themselves, and a considerable improvement in the stability to heat and to ultraviolet rays of the materials obtained, properties much appreciated in the sector.

Indeed, metal salts such as those of tin catalyse the degradation reaction of oxidation and are very toxic products, highly polluting for the environment.

The products described in examples 10 and 11 are evaluated both in the absence of the hydrolysis/condensation reaction catalyst for the terminal silane groups and with added catalysts known in the art, namely the metal compound dibutyltin dilaurate (DBTL) and the amine catalyst 1,8-diazabicyclo[5.4.0]undec-7-ene (DBU) in varying proportions as described in examples 10 and 11.

Approximately 3.5 g of formulation sample is placed in a PTFE dish-type sample holder of 34 mm diameter and 5 mm height and the entirety is placed in a chamber temperature controlled at 23° C.±1° C. and relative humidity of 50%±5%. The reactivity is evaluated by monitoring the formation of surface skin over time, placing the exposed surface in contact with a polyethylene sheet

See Table 3.

TABLE 1

| | Time (minutes) | | | | | | |
|---|---|---|---|---|---|---|---|
| Catalyst | | | | | | | Ex. 6 |
| (% | Ex. A | Ex. 1 | Ex. 2 | Ex. 3 | Ex. 4 | Ex. 5 | (0/ |
| weight) | (100/0) | (66/33) | (50/50) | (33/66) | (25/75) | (0/100) | 100) |
| 0 | >720 | 80 | 72 | 65 | 65 | 28 | 20 |
| DBTL | 45 | 35 | 28 | 21 | 18 | 5 | 3 |
| 0.025 | | | | | | | |
| DBTL | 25 | 7 | 7 | 3 | — | — | — |
| 0.12 | | | | | | | |
| DBU | >720 | 40 | 32 | 24 | 20 | 5 | 3 |
| 0.05 | | | | | | | |

TABLE 2

Time (minutes)

| Catalyst | Ex. B | Ex. 7 | Ex. 8 | Ex. 9 |
|---|---|---|---|---|
| (% weight) | (100/0) | (40/60) | (25/75) | (5/95) |
| 0 | >1500 | 210 | 150 | 34 |
| DBTL | >720 | 60 | 42 | 7 |
| 0.025 | | | | |
| DBTL | 480 | 26 | 18 | 4 |
| 0.12 | | | | |
| DBU | >1500 | 130 | 110 | 65 |
| 0.05 | | | | |
| DBU | >1500 | 28 | 23 | 10 |
| 0.1 | | | | |

TABLE 3

| | |
|---|---|
| Catalyst | |
| (parts by | Time (minutes) |

| weight)) | Ex. C | Ex. 10 | Ex. D | Ex. 11 |
|---|---|---|---|---|
| 0 | 6 h | 40 min | >10 h | 50 min |
| DBTL | 3 h | 30 | 9 h | 35 |
| 0.025 | | | | |
| DBTL | 1 h | — | 6 h | — |
| 0.3 | | | | |
| DBU | 6 h | 30 min | — | 70 min |
| 0.05 | | | | |
| DBU | 5 h | 20 min | 8 h | 25 min |
| 0.1 | | | | |

1. Silane-terminated prepolymers obtained by introducing silane groups into a polymer by adding an organic silicon derivative, wherein said silane-terminated prepolymers present, on at least one silicon atom, at least one hydrolyzable aryloxy type functional group comprising at least ten carbon atoms.

2. Silane-terminated prepolymers as claimed in claim 1 wherein said aryloxy group is chosen from a substituted phenoxy group, or a substituted phenoxy group onto which at least one other aromatic ring, such as naphthyloxy, is condensed.

3. Silane-terminated prepolymers as claimed in claim 2 wherein the aryloxy groups are chosen from the class consisting of: naphthyloxy, phenoxy substituted at the o-, and/or m-, and/or p-positions with linear or branched C₄-C₂₀ alkyl, alkylaryl, alkoxy, phenyl, substituted phenyl, thioalkyl, carboxyalkyl, carboxyamide, NHR groups in which R is a linear or branched C₄-C₅ alkyl or phenyl.

4. Silane-terminated prepolymers as claimed in claim 3 wherein said aryloxy groups are chosen from p-t-butyl-phenoxy, linear or branched p-C₄-C₁₂ alkyl-phenoxy, phenyl-phenoxy.

5. Silane-terminated prepolymers as claimed in claim 1, containing between 0.5 and 100 mol % of aryloxy groups on the total moles of hydrolyzable substituents present on all the silicon atoms.

6. Silane-terminated prepolymers as claimed in claim 5, containing between 5 and 100 mol % of aryloxy groups on the total moles of hydrolyzable groups present on all the silicon atoms.

7. Silane-terminated prepolymers as claimed in claim 1, wherein said organic silicon derivative presents the following general formula (1): 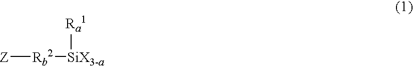
with a=0, 1, 2; b=0, 1 and where:
X=aryloxy, halogen, alkoxy, hydroxy, acyloxy, ketoximino, amino, amido and mercapto,
R¹=linear or branched C₁-C₂₀ alkyl
R²=divalent substituent chosen from the group consisting of linear or branched C₁-C₂₀ alkylene, heterocycloalkylenes, aminoalkylenes,
Z=substituent chosen from the group consisting of: 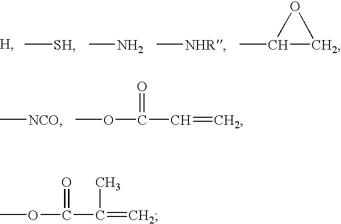
in which R″ represents a monovalent hydrocarbon group or a monovalent group able to form a heterocycloalkyl with the nitrogen atom, on the condition that when X is always different from aryloxy comprising at least ten carbon atoms, the silane-terminated prepolymers obtained with these derivatives are converted into silane-terminated prepolymers containing at least one aryloxy group comprising at least ten carbon atoms on at least one silicon atom by reaction with the corresponding aryl alcohol.

8. Silane-terminated prepolymers as claimed in claim 7 wherein the organic silicon derivatives are chosen from those that present the following formulae:
O═C═N—R³—Si(R⁴)ₙ(OR⁵)₃₋ₐ (1a)
H₂N—R³—Si(R⁴)ₙ(OR⁵)₃₋ₐ (1b)
O[CH₂—CH]—CH₂—O—R³—Si(R⁴)ₐ(OR⁵)₃₋ₐ (1c)
HS—R³—Si(R⁴)ₙ(OR⁵)₃₋ₐ (1d)
CH₂═C(R⁶)—COO—R³—Si(R⁴)ₐ(OR⁵)₃₋ₐ, (1e)
HL-R³—Si(R⁴)ₐ(OR⁵)₃₋ₐ (1f)
where:
R³=divalent alkyl radical containing from 1 to 8 carbon atoms;
R⁴ and R⁵=alkyl radicals containing from 1 to 4 carbon atoms and/or aryl radicals;
L is a divalent group consisting of a 5- or 6-atom saturated heterocyclic ring containing at least one nitrogen atom.

9. Silane-terminated prepolymers as claimed in claim 8 wherein the aryl group is a possibly substituted phenyl, or a possibly substituted phenyl on which at least one other aromatic ring is condensed.

10. Silane-terminated prepolymers as claimed in claim 9 wherein the aryl groups are chosen from: phenyl, naphthyl possibly substituted at the o-, and/or m-, and/or p-positions with:
linear or branched C₁-C₂₀ alkyl, alkylaryl (e.g. cumyl), alkoxy, phenyl, phenoxy, substituted phenyl, thioalkyl, nitro, halogen, nitrile, carboxyalkyl, carboxyamides, NH₂, NHR groups in which R is a linear or branched C₁-C₅ alkyl or phenyl.

11. Silane-terminated prepolymers as claimed in claim 10 wherein the aryl is chosen from phenyl, linear or branched p-C₁-C₁₂ alkyl phenyl, p-phenyl-phenyl.

12. Silane-terminated prepolymers as claimed in claim 8 wherein L is the divalent residue of piperazine.

13. Silane-terminated prepolymers as claimed in claim 1 chosen from:
A) Silane-terminated polyesters,
B) Silane-terminated polyurethanes,
C) Silane-terminated polyethers,
D) Silane-terminated prepolymers in which the main polymer chain is obtained by Michael polyaddition reaction of an organic derivative having at least 2 active hydrogens with organic compounds having at least two olefinic unsaturations, activated by the presence of an electronegative group in the alpha position with respect to each of said unsaturations.

14. Silane-terminated prepolymers as claimed in claim 13 belonging to class (D).

15. Silane-terminated prepolymers as claimed in claim 14 wherein said organic compounds having at least two olefinic unsaturations activated by the presence of an electronegative group in the alpha position with respect to each of said olefinic unsaturations, are chosen from the group consisting of:
W′[—C(R⁷)═CH₂]₂ (9)
Q[-W—C(R⁷)═CH₂]₂ (9a)
Q[-W—C(R⁷)═CH₂]₃ (9b)
Q[-W—C(R⁷)═CH₂]₄ (9c)
where:
W′=electron attracting group chosen from the group consisting of:
—SO—, —SO₂—, —O—, —CO—;
W=electron attracting group chosen from the group consisting of:
—SO—, —SO₂—, —O—, —CO—, —O—CO—;
R⁷═—H or —CH₃;
Q=divalent, trivalent or tetravalent group chosen from the group consisting of hydrocarbon, hetero-hydrocarbon, polyether, polyester radicals that can contain a repeating unit and hence have a variable molecular weight.

16. Silane-terminated prepolymers as claimed in claim 14 wherein said organic compounds having at least two olefinic unsaturations activated by the presence of an electronegative group in the alpha position with respect to each of said olefinic unsaturations, are acrylic and/or methacrylic organic compounds of general formula: 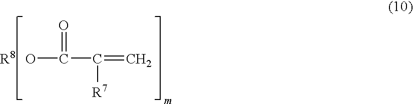
where
m=2, 3, 4;
R⁷═H or CH₃;
R⁸ is chosen from the group consisting of: a di-, tri- or tetra-valent polyether which essentially consists of chemically combined —OR⁹ units, where R⁹ is a divalent alkyl group having from 2 to 4 carbon atoms; di-, tri- or tetra-valent linear or branched aliphatic alkyl radical preferably from 1 to 50 carbon atoms; di-, tri- or tetra-valent aromatic radical, preferably from 6 to 200 carbon atoms; di-, tri- or tetra-valent linear or branched aryl radical, preferably from 6 to 200 carbon atoms, or R⁸ is one or more combinations of said polyethers, alkyl radicals, aromatic radicals and aryl radicals.

17. Silane-terminated prepolymers as claimed in claim 14 chosen from:
compounds of general formula (11) 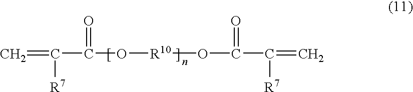
where:
—R⁷═H or CH₃;
R¹⁰ is chosen from the group consisting of —CH₂—CH(CH₃)—, —CH₂—CH₂—, —CH₂—CH₂—CH₂—CH₂—; —CH₂—CH(CH₃)—CH₂—; n′=a whole number from 1 to 400, preferably from 1 to 200 and even more preferably from 1 to 50; or
compounds of formula:
Error! Objects cannot be created from editing field codes.
where n is a whole number from 0 to 10 and R⁷ is H or CH₃.

18. Silane-terminated prepolymers as claimed in claim 17, wherein the polymers (11) are chosen from polyisopropylene glycol diacrylates, polybutylene diacrylates.

19. Silane-terminated prepolymers as claimed in claim 14, wherein said organic derivatives containing at least 2 active hydrogens are chosen from: sulphydric acid, HS(CH₂)ₙSH, HSPhSH, CH₃(CH₂)₃NH₂, H₂N(Ph)NH₂, piperazine, H₂N(CH₂)ₙNH₂, CH₃NH(CH₂)ₙNHCH₃, CH₂(COOH)₂.

20. Moisture-curing adhesive sealant formulation containing at least one silane-terminated prepolymer claimed in claim 1.
